(19) United States
(12) Patent Application Publication
(10) Pub. No.: US 2007/0177303 A1
(43) Pub. Date: Aug. 2, 2007

(54) Head cleaning mechanism

(75) Inventors: Stephen J. Stamm, Wheat Ridge, CO (US); Ray Chapman, Boulder, CO (US); Joe K. Jurneke, Brighton, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/345,879

(22) Filed: Feb. 1, 2006

(51) Int. Cl. G11B 5/41

(52) U.S. Cl. 360/128

(57) ABSTRACT

A cleaning apparatus for cleaning a media drive transducer head is provided. In one example, the apparatus includes a cleaning member (e.g., a brush having a plurality of bristles) and an actuator assembly operable to move the cleaning member from a position vertically offset from a drive head to a position engaging the drive head, the vertical direction being perpendicular to the direction of tape transport adjacent the drive head. The apparatus may further include a displacement feature operable to engage a leader member (e.g., the drive leader or tape) and displace the leader member from the drive head.

### BACKGROUND

1. Field

The present invention relates generally to systems and methods for cleaning media drive heads, and in one example to a low-profile apparatus for cleaning a media drive head.

2. Related Art

Tape media cartridges have proven to be an efficient and effective medium for data storage in computer systems. For example, magnetic tape cartridges generally include a housing containing a tape coated with a magnetic coating that can be used to record large amounts of data. The tape is generally wound around a reel, and may be fed from the cartridge to a data reading or writing device through a hinged door in the surface of the cartridge. Data stored on these cartridges may be read and/or written by a data transducer head (e.g., a read and/or write head) as part of a tape drive.

The accuracy of data transfer may be adversely affected by debris or contamination on the tape or on the data transducer head. The build up of debris on the drive head may damage the tape, the tape cartridge, and/or the tape drive, as well as decrease the performance of the drive head. Various devices and methods for cleaning transducer heads and magnetic tape have been described. For example, a cartridge housing a dedicated cleaning tape, commonly referred to as a “cleaning cartridge,” may be used to clean a tape transducer head. A cleaning cartridge may include a tape that is manufactured with particular mechanical and/or chemical properties that provide increased abrasiveness to clean debris from the transducer head of the drive.

Conventional cleaning cartridges, however, generally do not provide a cleaning portion that removes debris from within grooves or slots of the media drive head, thereby decreasing the performance of the media drive head. For example, a head may include grooves for specific performance issues, such as air bleeding or the like, and as the grooves are filled with debris, which can migrate into the active elements, the performance of the head may suffer.

Additionally, drives may include a mechanical apparatus for selectively engaging and cleaning the drive head. Typically, such internal mechanical apparatus use valuable space within the media drive housing.

### BRIEF SUMMARY

In one aspect of the present invention an apparatus for cleaning a media drive transducer head is provided. In one example, the apparatus includes a cleaning member (e.g., a brush having a plurality of bristles) and an actuator assembly operable to move the cleaning member from a position vertically offset from the drive head to a position engaging the drive head, the vertical direction being perpendicular to the direction of tape transport adjacent the drive head. The apparatus may further include a displacement feature operable to engage a leader member (e.g., the drive leader or tape) and displace the leader member from the drive head.

In one example, the apparatus is operable to move the cleaning member from a retracted non-vertical (and in one example, substantially horizontal) orientation to an extended vertical orientation for engaging and cleaning the surface of the drive head. The example may provide for a relatively low-profile cleaning apparatus that is vertically offset from the drive head. The cleaning member may be guided by an appropriate cam profile that moves the cleaning member and supporting structure from substantially horizontal motion to substantially vertical motion to engage and clean the drive head.

In another aspect of the present invention a media drive is provided. The media drive includes a drive head having at least one data transducer, a drive leader, and a cleaning apparatus. The cleaning apparatus may include a cleaning member and an actuator assembly operable to move the cleaning member from a position vertically offset from the drive head to a position engaging the drive head, the vertical direction being perpendicular to the direction of tape transport adjacent the drive head. The cleaning member may be moved from a substantially horizontal orientation vertically offset from the head to a vertical orientation engaging the head surface. Further, the cleaning apparatus may include a displacement feature operable to engage the drive leader and displace the drive leader from the drive head.

In another aspect of the present invention, a method for cleaning a drive head is provided. In one example the method includes moving a cleaning member from a position vertically offset from a drive head to a position engaging the drive head, the vertical direction being perpendicular to the direction of tape transport adjacent the drive head, and displacing a leader member away from the drive head to allow the cleaning member to engage the drive head.

The present inventions and various aspects are better understood upon consideration of the detailed description below in conjunction with the accompanying drawings and claims.

### BRIEF DESCRIPTION OF THE DRAWINGS

FIG. 1 illustrates an exemplary media drive and an exemplary tape cartridge;

FIGS. 2A and 2B illustrate a portion of a media drive and an exemplary head cleaning apparatus in a retracted position;

FIG. 3 illustrates a portion of a media drive and an exemplary head cleaning apparatus in an extended, cleaning position; and

FIGS. 4A-4D schematically illustrate a cross-sectional view of an exemplary head cleaning apparatus motion.

### DETAILED DESCRIPTION

The following description is presented to enable any person of ordinary skill in the art to make and use various aspects and examples of the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

Many tape drives include very densely packed components in an effort to reduce the size of the tape drive. Further, tape drives often include many components positioned adjacent to the drive head (along a direction of the tape path). These factors make it difficult to bring a cleaning mechanism in from the side of the drive head, i.e., along the direction of the tape path, to clean the drive head. Accordingly, in one example described herein, an apparatus for cleaning a drive head includes a cleaning brush mounted to a movable member that moves the cleaning brush from above (or alternatively, from below) the drive head to engage and clean the drive head. For example, the cleaning brush moves laterally with respect to the tape path by the drive head from a position vertically offset from the head. In one example, to reduce the height of the overall cleaning mechanism and drive housing, the cleaning brush moves from a substantially horizontal orientation (or at least non-vertical orientation) positioned above the head to a vertical orientation adjacent the drive head surface.

The cleaning apparatus may further include a deflection feature or member operable to move or deflect a leader member (cartridge or drive leader) or tape away from the head prior to or as the cleaning brush engages the head. Additionally, in one example, when the cleaning brush is positioned at the drive head, the drive head may be actuated, e.g., moved relative to the cleaning brush, to further facilitate cleaning.

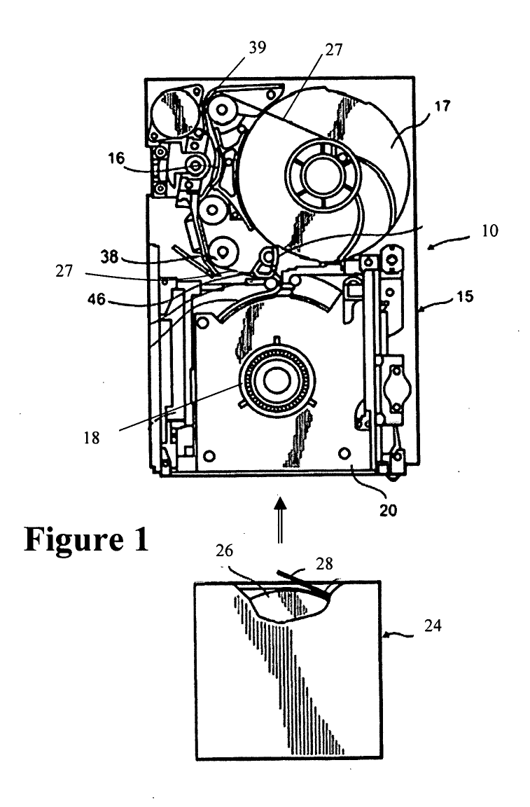

Referring initially to FIG. 1, an exemplary tape drive 10 which may include a head cleaning mechanism as described herein is shown. Tape drive 10 is typically installed within or associated with a computer system (not shown) or computer network. Additionally, tape drive 10 may be used as part of an automated tape library having a plurality of tape cartridges and a robotic transfer mechanism to transport cartridges to one or more tape drives. An exemplary storage library is described in U.S. Pat. No. 5,760,995, entitled “MULTI-DRIVE, MULTI-MAGAZINE MASS STORAGE AND RETRIEVAL UNIT FOR TAPE CARTRIDGES,” which is hereby incorporated by reference in its entirety.

A representative magnetic tape drive for which an exemplary storage cartridge may be used is sold by Quantum Corporation under the trademark Celeritas™ or SDLT™ 600. Further, various examples herein are described with reference to magnetic tape drives; it will be understood by one of ordinary skill in the art, however, that the description of magnetic tape drives is illustrative only and the exemplary systems and methods are applicable to various data storage tape drives including, but not limited to, magnetic, optical, and magnetic/optical drive systems.

Tape drive 10 includes a tape drive housing 15, a data transducer, i.e., read and/or write head 16, a take-up reel 17, and a receiver slot 20. Tape drive 10 is used in conjunction with cartridge 24, which includes a cartridge leader 28 and supply reel 26. Receiver slot 20 is configured to receive a suitable cartridge 24 therein adjacent reel driver 18. Tape drive 10 may also include a door and various mechanisms for receiving and ejecting cleaning cartridge 24.

When cartridge 24 is received in receiver slot 20 a buckler motor 46 or the like engages cartridge leader 28 to couple the drive leader 27 to cartridge leader 28, and stream cartridge leader 28 from cartridge 24 along a path within tape drive 10 passing read/write head 16. The path may include various tape guides 39, rollers 38, one or more read/write heads 16, and the like before being wound upon take-up reel 17.

Tape drive 10 further includes or communicates with a controller (not shown). The controller is in electrical communication with tape head 16, and can direct and detect electrical current to and from the tape head 16 for reading of data from and/or writing data to the storage medium of cartridge 24. Further, the controller generally operates to control the movement of drive leader 27 and may move head 16, e.g., up and down during read and/or write operations as well as during cleaning processes.

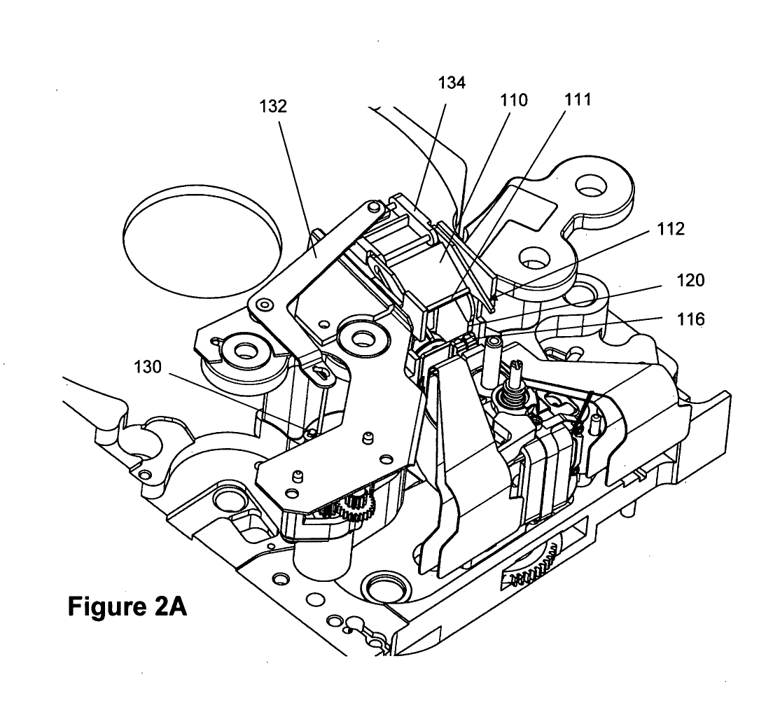

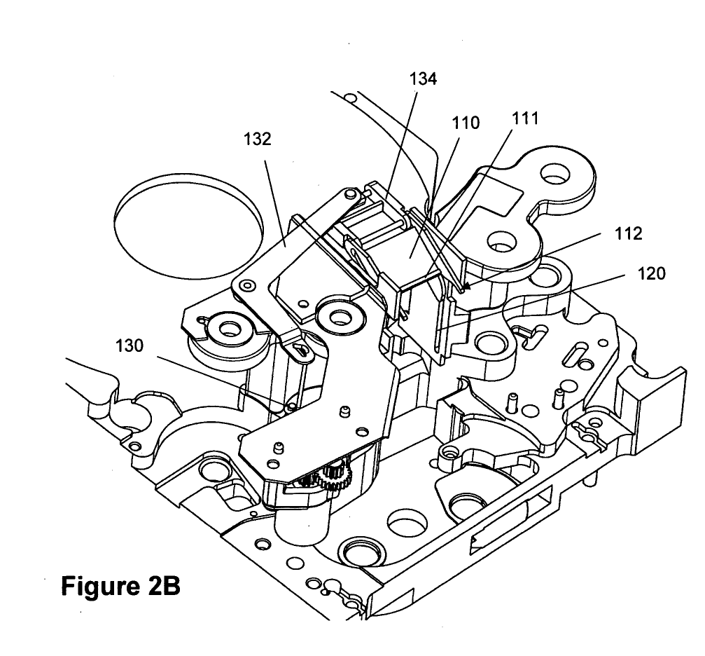

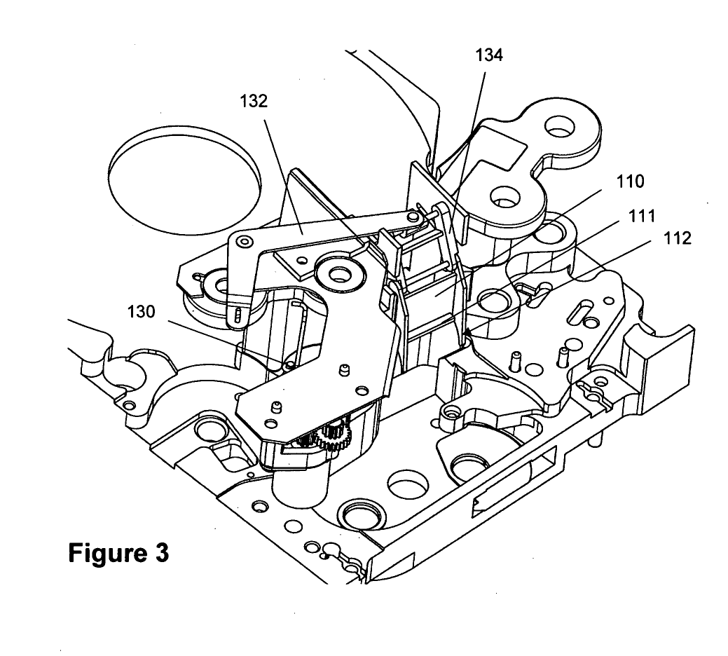

FIGS. 2A and 2B illustrate a portion of a media drive and an exemplary head cleaning apparatus in a retracted position and FIG. 3 illustrates the exemplary head cleaning apparatus in an extended position. In particular, FIG. 2A illustrates a movable support member 110 for supporting a cleaning member 111 in a position vertically above head 116, and FIGS. 2B and 3 illustrate the exemplary media drive and head cleaning apparatus of FIG. 2A with several components removed for illustrative purposes in a retracted and extended position respectively.

As illustrated in FIG. 2A, the exemplary media drive includes various components positioned in close proximity to head 116, such that space is limited for positioning a cleaning brush to engage head 116. In some example, a tape drive may include a servo system, with some portions of the servo system, e.g., servo optics, disposed on the back side of the tape path, e.g., opposite head 116. Such a system may result in an optical reader positioned approximately 0.050 inches away from the surface of the head 116, for example. Additionally, within this gap between head 116 and an optical servo system is positioned the drive leader and head protect shutter (when the drive is in an unloaded state).

Accordingly, in this example a cleaning member 111, e.g., a brush, is attach to support member 110 and is moved from a position above head 116 to a vertical position facing and engaging head 116. Generally, support member 110 is driven by a motor 130, which is coupled to support member 110 via pivoting arm 132 and link coupling member 134. It will be understood that various other components may be included to couple motion from motor 130 to support member 110. In this example, support member 110 and cleaning member 111 are guided, at least in part, by cam profile 120 (seen more clearly in FIG. 2B).

As support member 110 is moved by motor 130, cam profile 120 guides support member 110 from a substantially horizontal orientation (FIGS. 2A and 2B) to a substantially vertical orientation (FIG. 3). The horizontal and vertical orientations are generally described relative to drive head 116 and the tape path through the drive, e.g., where the vertical direction is taken as perpendicular to the direction of tape transport adjacent head 116 and parallel to the surface of head 116. Cleaning member 111, attached to support member 110, engages drive head 116 when support member 110 is positioned in a vertical orientation and the cleaning member 111 faces drive head 116 (as shown in FIG. 3). In this example, cam profile 120 further guides member 110 and cleaning member 111 attached thereto in a vertical direction adjacent head 116. During at least a portion of the vertical motion of support member 110, cleaning member 111 engages and removes debris from head 116 (in particular from grooves or slots of head 116).

In this example cam profile 120 includes a curved slot which engages a boss, pins, or other member associated with support member 110. In other examples, cam profile 120 may include a linear slot to move support member 110 from a vertically offset position to engage head 116 as described. Additionally, the boss or pins and the cam profile could be reversed, e.g., the cam profile associated with support member 110.

Initially, the motion of support member 110 is substantially horizontal motion above head 116 and other drive components such as the roller guide bearing tower. As support member 110 moves over the location to engage the drive leader the motion of support member 110 transitions from primarily horizontal motion to primarily vertical motion as set by the cam profile 120.

Additionally, the shape of cam profile 120 is designed such that deflection member 112 associated with support member 110 displaces the drive leader (or other member positioned adjacent head 116) away from the surface of head 116. In one example, deflection member 112 lifts the drive leader off and away from the surface of head 116 such that a cleaning member may engage head 116. In other examples, deflection member 112 may push a leader or tape down vertically and away from head 116 to allow the cleaning brush to engage head 116.

After or as the leader is moved off or away from the surface of head 116 by deflection member 112, support member 110 moves in a vertical direction to engage and clean head 116 with cleaning member 111, e.g., a brush comprising a plurality of bristles to remove debris from the drive head surface and gaps. The cleaning member 111 may be moved vertically several times with respect to head 116 if desired by either partial movements or completely repeating the movement described (from the retracted position above head 116 to the extended position engaging head 116). Additionally, head 116 may be actuated to move up and down when cleaning member 111 is engaged therewith.

A controller included with or associated with a tape drive may include one or more cleaning algorithms for controlling and using the cleaning mechanism, and in particular, the motor 130 and/or head 116. Exemplary methods and algorithms for moving the cleaning member may be carried out in software, firmware, hardware, or combinations thereof and included, e.g., in at least one of the media drive and associated computer system or network. The exemplary methods may also be included in a computer readable storage medium containing computer executable code.

In one example, the cleaning member of the cleaning apparatus includes a brush having a plurality of fibers or bristles. The bristles of the cleaning brush may include one or more materials such as synthetic fibers, carbon, stainless steel, or the like. The fibers or bristles may be integrated into and projected generally away from a backing or other member by, for example, sewing, weaving, bonding or otherwise fixing the fibers in place. In one example, the fibers and/or backing are made from electrically conductive or statically dissipative materials to minimize electro-static charge build-up, thereby protecting transducer elements of the head. Electrically conductive or statically dissipative materials may avoid static discharge when contacting a drive head (which may damage transducer elements of the drive head). One such example includes a pad brush produced under the trademark name Thunderon™ (the acrylic fibers of the brush developed by Nihon Sanmo Dyeing Co., Ltd.). The cleaning brush may further be milled, cut, shaved, or otherwise reduced in height for a particular application or desired height. In other examples, the cleaning member may include other structures such as cloth pads, abrasive materials (such as aluminum oxide), and the like.

In one example, the diameter and height of the cleaning brush bristles are sufficient to reach into the grooves and slots of a drive head to remove debris therefrom. Additionally, a relatively low profile may also be desired to ensure the cleaning brush is sufficiently flexible and thin to move through the drive without causing drive errors or the like, e.g., to fit clearances such as between the drive head and an opposing optical or magnetic servo assembly. Accordingly, the dimensions of the support member 110, cleaning member, and other associated structure may vary depending on the particular drive head characteristics and drive tape path. In one example, the height of the cleaning brush bristles is less than 0.1 inches. In another example, the height is about 0.05 inches; in another example, equal to or less than 0.05 inches, and in another example, equal to or less than 0.03 inches.

The diameter of the cleaning brush bristles may also vary depending on the particular groove or slot dimensions of the drive head. In one example, the diameter of individual bristles is approximately equal to or less than the gap widths of the grooves or slots of the tape head. In another example, the bristle diameter is equal to or less than 0.9 times the gap widths of the tape head; and in another example, equal to or less than 0.8 times the gap widths of the tape head.

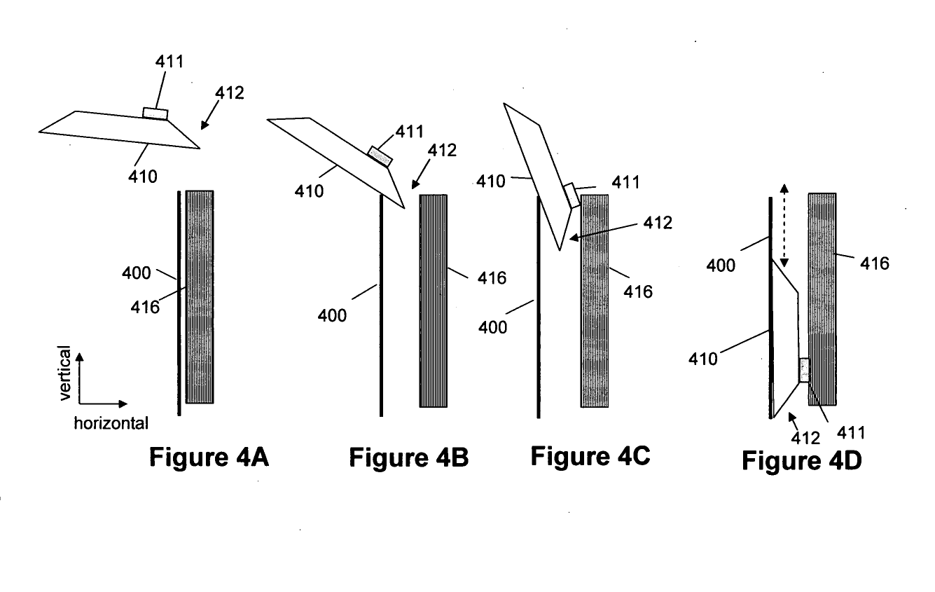

FIGS. 4A-4D schematically illustrate a cross-sectional view of an exemplary head cleaning apparatus moving to displace leader 400 and engage head 416, which may be similar to that shown in FIGS. 2A-3. FIG. 4A illustrates support member 410 supporting cleaning member 411 in a retracted position vertically offset from head 116. Leader 400 is illustrated adjacent head 416, where leader 400 travels in a longitudinal direction by head 416 (into/out the page as shown). The retracted position of member 410 and cleaning member 411 is illustrative only, and could be positioned and oriented differently. For example, the orientation of member 410 need not be substantially horizontal, and support member 410 could also be retracted in a position vertically below head 416. Additionally, support member 410 and cleaning member 411 could be positioned vertically offset and on an opposite side of leader 400 from head 416.

As support member 410 and cleaning member 411 move from the horizontal position to the vertical position, a drive head protect shutter (not shown, but often included with a tape drive) is rotated out of the path of support member 410 and cleaning member 411. As support member 410 moves (e.g., by a suitable actuator assembly) a deflection feature 412 engages and deflects or lifts leader 400 away from the surface of head 416 as shown in FIG. 4B, thereby allowing the bristles to contact head 416 through the continued vertical motion.

In this example, deflection feature 412 includes an angled surface to engage and guide leader 400 away from head 416 during motion of support member 410. Deflection feature 412 may include a feature attached and fixed with member 410. In other examples, deflection feature 412 may move relative to member 410.

As member 410 continues to move, the orientation and motion becomes more vertical as seen in FIG. 4C. In one example, member 410 may be guided by a cam profile as described above. In other examples, member 410 may be attached to an arm or other structure which moves member 410 in a fashion as described.

Support member 410 and cleaning member 411 then move vertically with respect to head 416 to engage and clean head 416. Support member 410 may move up and down vertically once or several times while engaging head 416. In other samples, the entire motion shown by FIGS. 4A-4D may be repeated in succession. Additionally, head 416 may be moved up and down to further facilitate the cleaning process.

The above detailed description is provided to illustrate exemplary embodiments and is not intended to be limiting. It will be apparent to those skilled in the art that numerous modifications and variations within the scope of the present invention are possible. Throughout this description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

1. A cleaning apparatus for use with a tape media drive head, comprising:
a cleaning member;
an actuator assembly operable to move the cleaning member from a position vertically offset from a drive head to a position engaging the drive head, the vertical direction being perpendicular to the direction of tape transport adjacent the drive head; and
a displacement feature operable to engage a leader member and displace the leader member from the drive head.

2. The apparatus of claim 1, wherein the cleaning member moves from a non-vertical orientation to a vertical orientation to engage the drive head.

3. The apparatus of claim 2, wherein the cleaning member is attached to a support member that follows a cam profile operable to guide the cleaning member from the non-vertical position to the vertical orientation.

4. The apparatus of claim 1, wherein the cleaning member moves from a substantially horizontal orientation to a vertical orientation to engage the drive head.

5. The apparatus of claim 4, wherein the cleaning member is attached to a support member that follows a cam profile operable to guide the cleaning member from the substantially horizontal orientation to the vertical orientation.

6. The apparatus of claim 1, wherein the cleaning member comprises a brush having a plurality of bristles.

7. The apparatus of claim 6, wherein the bristles have a height of less than 0.1 inches.

8. The apparatus of claim 6, wherein the bristles comprise an electrically conductive material.

9. A tape media drive, comprising:
a drive head having at least one data transducer;
a drive leader; and
a cleaning apparatus, the cleaning apparatus comprising:
a cleaning member;
an actuator assembly operable to move the cleaning member from a position vertically offset from the drive head to a position engaging the drive head, the vertical direction being perpendicular to the direction of tape transport adjacent the drive head; and
a displacement feature operable to engage the drive leader and displace the drive leader from the drive head.

10. The media drive of claim 9, further comprising a controller comprising logic operable to activate the actuator assembly.

11. The media drive of claim 10, further comprising a controller comprising logic operable to move the transducer head when the cleaning member is located adjacent thereto.

12. The media drive of claim 9, wherein the cleaning member comprises a cleaning brush having a plurality of bristles.

13. The media drive of claim 12, wherein the bristles have a height of less than 0.1 inches.

14. The media drive of claim 12, wherein the bristles comprise an electrically conductive material.

15. The media drive of claim 9, wherein the cleaning member moves from a non-vertical orientation to a vertical orientation to engage the drive head.

16. The media drive of claim 9, wherein the cleaning member moves from a substantially horizontal orientation to a vertical orientation to engage the drive head.

17. A method for cleaning a drive head of a media drive, the method comprising:
moving a cleaning member from a position vertically offset from a drive head to a position engaging the drive head, the vertical direction being perpendicular to the direction of tape transport adjacent the drive head; and
displacing a leader member away from the drive head to allow the cleaning member to engage the drive head.

18. The method of claim 17, further comprising moving the cleaning member from a non-vertical orientation to a vertical orientation to engage the drive head.

19. The method of claim 17, further comprising moving the cleaning member from a substantially horizontal orientation to a vertical orientation to engage the drive head.

20. The method of claim 17, wherein the cleaning member comprises a cleaning brush having a plurality of bristles.

21. The method of claim 20, wherein the bristles have a height of less than 0.1 inches.

22. The method of claim 17, further comprising moving the data transducer head when the cleaning member is engaged with the drive head.
